(19) United States
(12) Patent Application Publication
(10) Pub. No.: US 2008/0264576 A1
(43) Pub. Date: Oct. 30, 2008

(54) Window covering

(76) Inventor: Li-Ming Cheng, Kaohsiung City (TW)

Correspondence Address: Joe McKinney Muncy, PO Box 1364, Fairfax, VA, 22038-1364, US

(21) Appl. No.: 11/790,242

(22) Filed: Apr. 24, 2007

(51) Int. Cl. E06B 9/36

(52) U.S. Cl. 160/168.1 V

(57) ABSTRACT

A window covering includes an upper elongated member, a lower elongated member, a slat assembly, a first lift cord, a second lift cord and a lift cord retracting and releasing control means which is located at the upper elongated member and cooperative with the first and second lift cords to control movement of the slat assembly. The first lift cord has one end fastened to the lift cord retracting and releasing control means and other end threading through the upper elongated member. The second lift cord has one end fastened and wound around the lift cord retracting and releasing control means and threading through the upper elongated member. After the slat assembly has been retracted or extended to a selected elevation, through the coupling relationship among the first and second lift cords and the lift cord retracting and releasing control means the slat assembly may be altered to another elevation to adjust indoor luminary condition.

### FIELD OF THE INVENTION

The present invention relates to a window covering and particularly to a window covering with a slat assembly adjustable to a selected elevation after retracted and extended.

### BACKGROUND OF THE INVENTION

A conventional window covering has a slat assembly which cannot be rolled up or lowered again after retracted or extended to further move the slat assembly separately and longitudinally to alter the elevation. As a result users cannot adjust the indoor luminary condition as desired. It still has problems such as not very practical, unstable operation and the like.

### SUMMARY OF THE INVENTION

The present invention aims to provide an improved window covering that allows a slat assembly already being retracted or extended to be moved longitudinally again to a desired elevation through a first lift cord and a second lift cord to facilitate adjustment of indoor luminary condition.

To achieve the foregoing object, the window covering of the invention mainly includes a upper elongated member, a lower elongated member, a slat assembly, a first lift cord, a second lift cord and a lift cord retracting and releasing control means. The lift cord retracting and releasing control means is located at one side of the upper elongated member. The lower elongated member is spaced from the upper elongated member at a lower side. The slat assembly has an upper end and a lower end coupled respectively to the upper elongated member and the lower elongated member. The first lift cord has one end fastened to the lift cord retracting and releasing control means and other end threading through the upper elongated member. The second lift cord has one end wound around the lift cord retracting and releasing control means and threading through the upper elongated member.

By means of such a structure the following functions can be achieved: through the first lift cord, second lift cord and lift cord retracting and releasing control means, the slat assembly can be rolled up or extended downwards; then through the structural and coupling relationship among the first lift cord, second lift cord and lift cord retracting and releasing control means, the slat assembly can be further lifted or lowered for a selected distance and anchored. Thus the elevation of the slat assembly can be altered to adjust the indoor luminary condition as desired.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is a perspective view of the lift cord retracting and releasing control means of the invention, partly exploded.

FIG. 3 is an exploded view of the lift cord retracting and releasing control means of the invention.

FIG. 4 is another exploded view of the lift cord retracting and releasing control means of the invention.

FIG. 5 is a schematic view of the lift cord retracting and releasing control means of the invention, partly cutoff.

FIG. 6 is a schematic view of the lift cord retracting and releasing control means in an assembled condition.

FIG. 7 is a schematic view of the window covering of the invention with the lower elongated member held by a user's hand for retracting or releasing.

FIG. 8 is an exploded view of the first gear and latch assembly of the latch roller set of the invention.

FIG. 9 is a schematic view of the ratchet wheel of the latch assembly in a rotating condition.

FIG. 10 is a schematic view of the ratchet wheel of the latch assembly in another rotating condition.

FIG. 11 is a top view of the lift cord retracting and releasing control means in an operating condition while the second lift cord is being pulled.

FIG. 12 is a schematic view of the invention showing the slat assembly released by the first lift cord.

FIG. 13 is a top view of the lift cord retracting and releasing control means in an operating condition while the first lift cord is being pulled.

FIG. 14 is a front view of the slat assembly in an extended condition.

### DETAILED DESCRIPTION OF THE PREFERRED EMBODIMENT

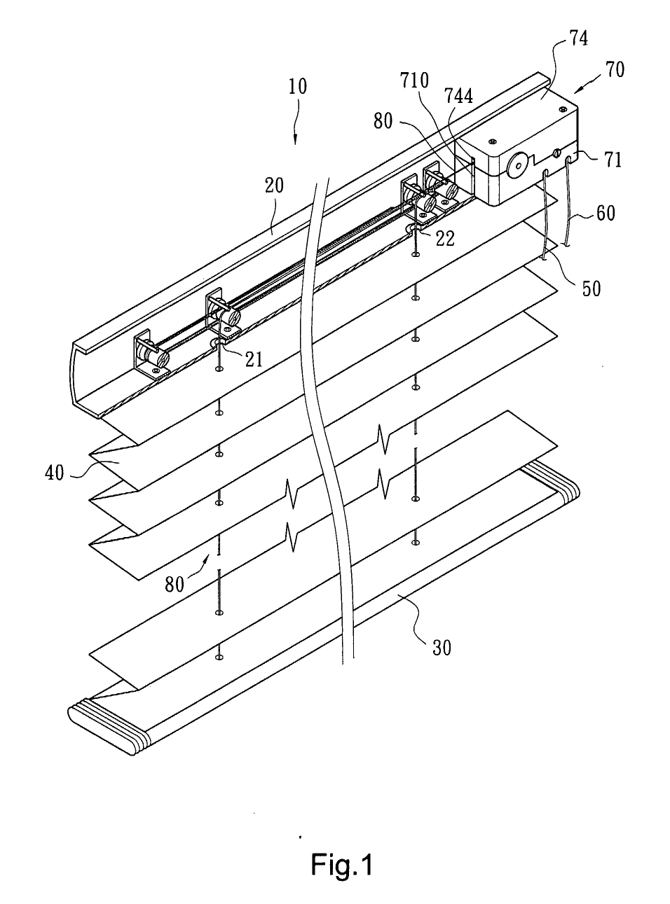

Please refer to FIG. 1, the window covering 10 according to the invention mainly includes an upper elongated member 20, a lower elongated member 30, a slat assembly 40, a first lift cord 50, a second lift cord 60 and a lift cord retracting and releasing control means 70. The upper elongated member 20 has a trough for the hold the lift cord retracting and releasing control means 70 which can wind and release the first lift cord 50 and the second lift cord 60. The upper elongated member 20 further has a plurality of openings formed on the bottom such as a first opening 21 and a second opening 22 shown in the drawing.

The second elongated member 30 is spaced from the upper elongated member 20 at a lower side. By pulling the lower elongated member 30 downwards or pushing it upwards with hands the slat assembly 40 can be retracted or released. The slat assembly 40 has a slat and lift cord assembly 80 which has an upper end and a lower end fastened respectively to the upper elongated member 20 and the lower elongated member 30. The first lift cord 50 aims to control the lower elongated member 30 to extend downwards in a staged fashion. It has one end fastened to the lift cord retracting and releasing control means 70 and other end threading through the upper elongated member 20. The second lift cord 60 aims to retract the lower elongated member 30 upwards in a staged fashion. It has one end fastened and wound around the lift cord retracting and releasing control means 70 and other end threading through the upper elongated member 20. Through the first lift cord 50, second lift cord 60 and lift cord retracting and releasing control means 70 the slat assembly 40 can be steadily rolled up and extended downwards at a selected elevation.

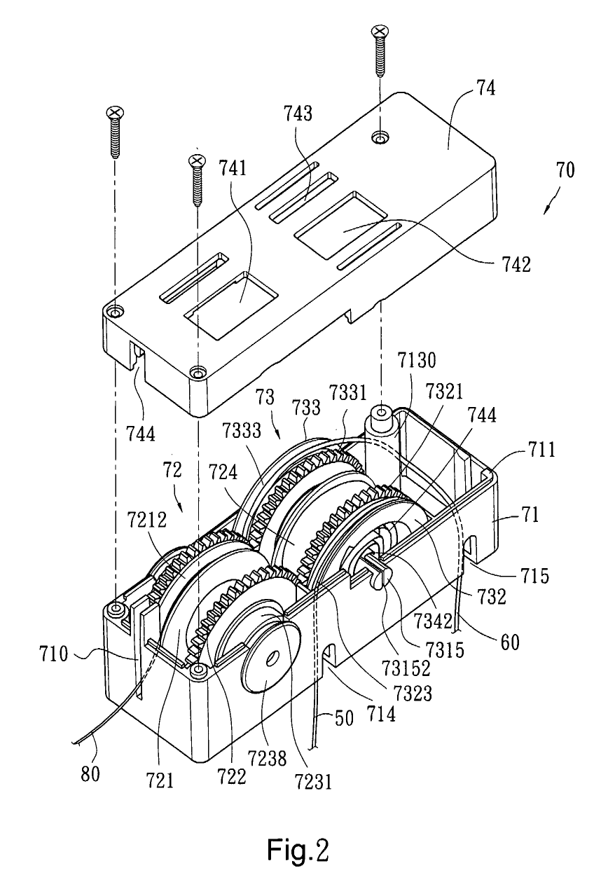

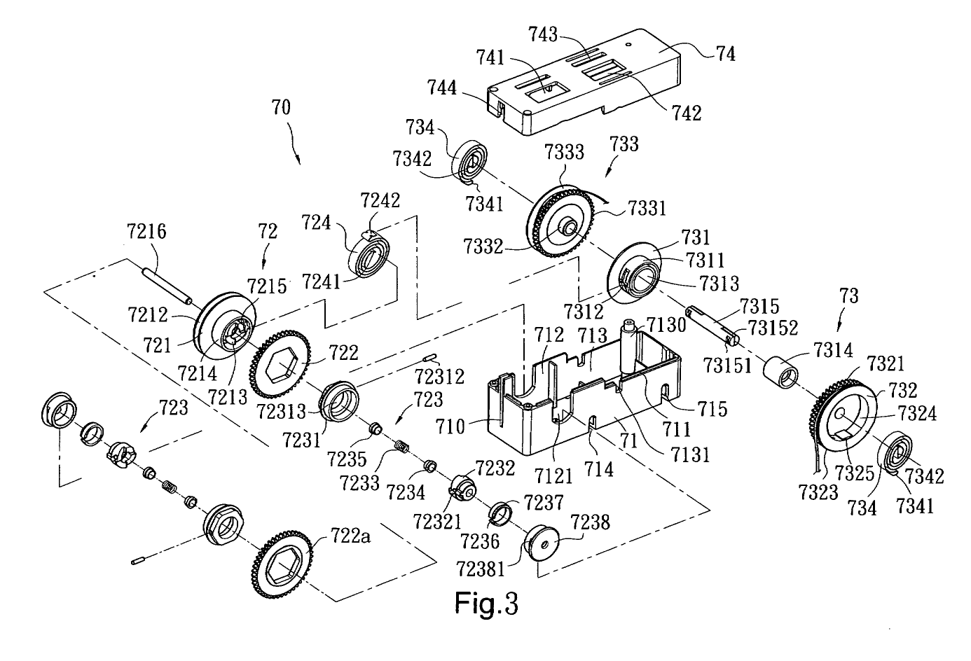

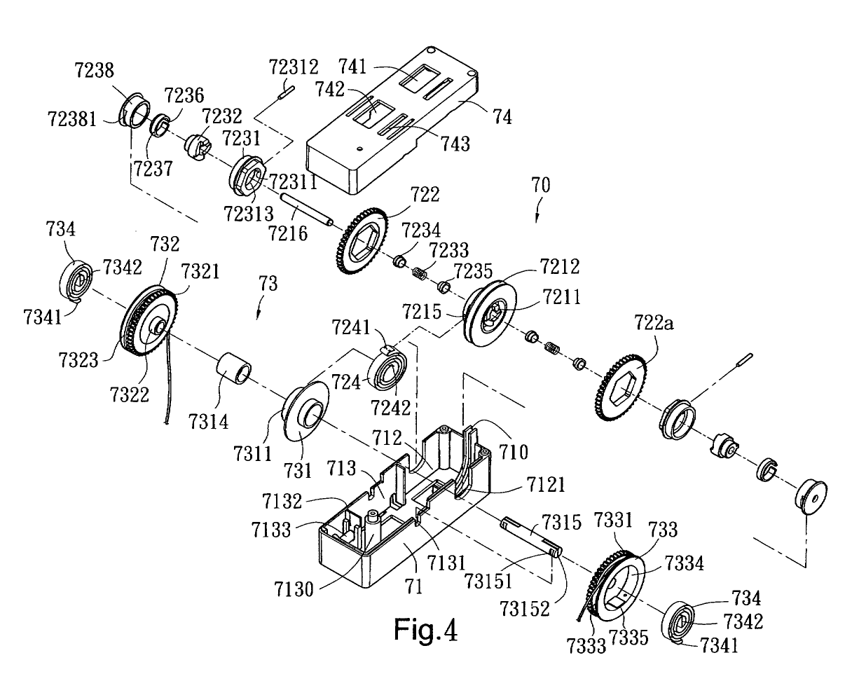

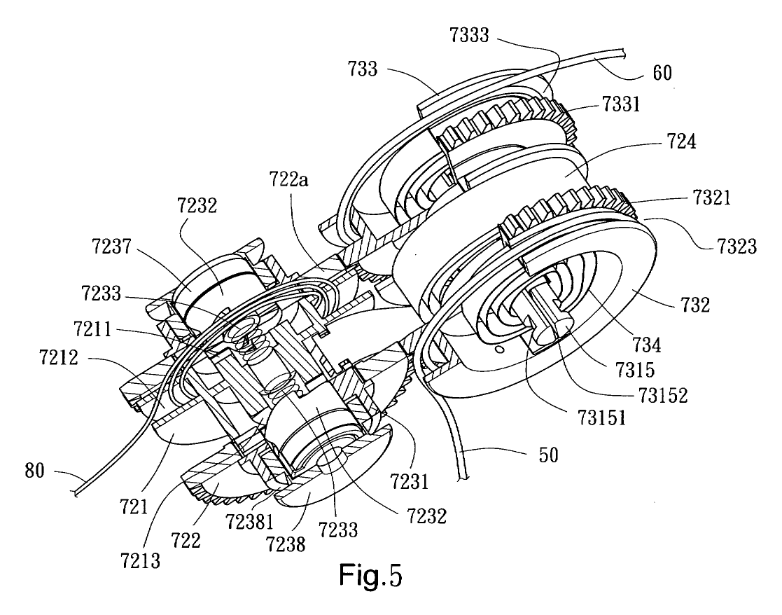

Also referring to FIGS. 2 through 6, the lift cord retracting and releasing control means 70 mainly includes a seat 71, a latch roller set 72, an auxiliary gear set 73 and an upper lid 74. The seat 71 is a box with a hollow upper portion and an anchor opening 710 at one side to receive the lift cord assembly 80. The seat 71 further has a recess 711 on an upper end and an interior divided into a first housing compartment 712 and a second housing compartment 713. The first housing compartment 712 has a first notch 7121 on each of two corresponding sides to hold the latch roller set 72. The second housing compartment 713 has a second notch 7131 on each of two corresponding sides to hold the auxiliary gear set 73. At a corner there is a directing trough 7132 opposing a guiding strut 7130 to latch a pulley 7133. The first and second housing compartments 712 and 713 has a front end bottom located there between with a first aperture 714 and a second aperture 715 formed thereon corresponding to the pulley 7133 at one side of the second housing compartment 713.

The latch roller set 72 is located in the first housing compartment 712 and anchored on the first notch 7121, and includes at least a winding wheel 721, a first gear 722, a second gear 722a, two latch assemblies 723 and an elastic element 724. The winding wheel 721 is held in the first housing compartment 712, and has a winding trough 7212 with a first ratchet wheel 7211 at one end, and a round strut 7214 at another end with a second ratchet wheel 7213 formed thereon. The round strut 7214 has a latch trough 7215 to hold an axle 7216. The winding trough 7212 aims to wind the lift cord assembly 80. The two latch assemblies 723 are hinged respectively on the first and second gears 722 and 722a, and include a positioning member 7231, a third ratchet wheel 7232, an elastic element 7233, a front holding member 7234, a second holding member 7235, an annular ring 7237 with a notch 7236 formed thereon, and a coupling member 7238. The positioning member 7231 is coupled on the first and second gears 722 and 722a, and has a pin hole 72311 at one side to receive a pin 72312, and a through hole 72313 inside to hold the third ratchet wheel 7232. It also has a slant flute 72321 on an outer side to direct the pin 72312 and turn the third ratchet wheel 7232. The elastic member 7233 is coupled with two ends of the axle 7216 and anchored by the front and rear holding members 7234 and 7235. The coupling member 7238 is held in the annular ring 7237 and coupled on two ends of the positioning member 7231. The coupling member 7238 further has a fastening trough 72381 at one end to be latched in the first notch 7121 of the seat 71. The elastic element 724 has latch elements 7241 and 7242 at two ends. One latch member 7241 is latched in the latch trough 7215 of the winding wheel 721.

The auxiliary gear set 73 is held in the second housing compartment 713 of the seat 71, and includes a spool 731, a first winding wheel 732, a second winding wheel 733 and two elastic elements 734. The spool 731 has a protrusive portion 7311 with a latch trough 7312 formed on an outer side. The elastic element 724 has a latch element 7242 at one end to latch in the latch trough 7312. The spool 731 further has an opening 7313 to hold a coupling member 7314 and a shaft 7315 which has a latch trough 73151 at one end and a latch flute 73152 at other end. The first and second winding wheels 732 and 733 are coupled on two ends of the shaft 7315 in opposite directions, and are held in the second housing compartment 713, and have gears 7321 and 7331 located at one end, and bosses 7322 and 7332 in the center with a through hole formed thereon. The bosses 7322 and 7332 receive the shaft 7315, and have respectively a winding trough 7323 and 7333 at another end. The winding troughs 7323 and 7333 allow the first and second lift cords 50 and 60 to thread through, and have housing chambers 7324 and 7334 formed inside. The housing chambers 7324 and 7334 have respectively a latch ditch 7325 and 7335 formed therein. The two elastic members 734 have a bend portion 7341 at one end to be latched in the latch ditches 7325 and 7335 of the housing chambers 7324 and 7334, and an insertion end 7342 at other end to be anchored in the latch flute 73152 at two ends of the shaft 7315. Thereby the first and second winding wheels 732 and 733 are held in the second housing compartment 713 with the latch trough 73151 at two ends of the shaft 7315 latched in the second notch 7131 at the corresponding side of the seat 71. The upper lid 74 covers the seat 71 at an upper side, and has a plurality of openings formed thereon. As depicted in an embodiment shown in the drawings, the openings may include a first, second and third slots 741, 742 and 743 to allow the winding wheel 721, first gear 722 and first and second winding wheels 732 and 733 to extend outside, and a coupling notch 744 at one side corresponding to the anchor opening 710.

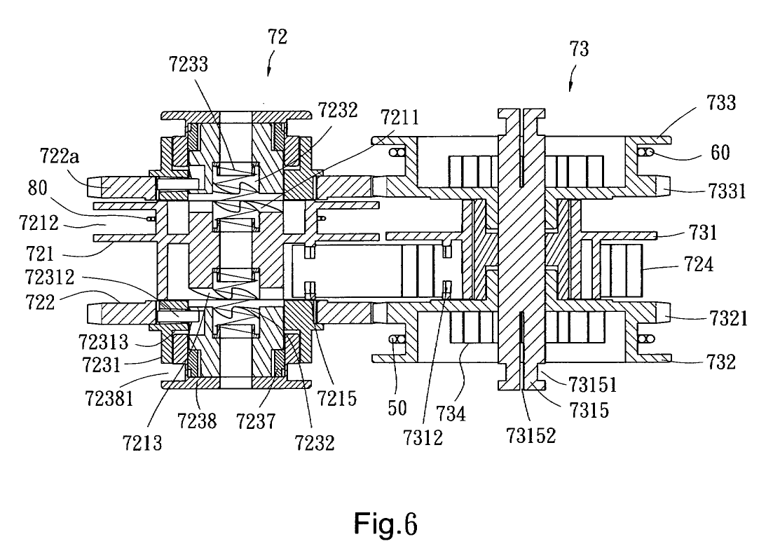

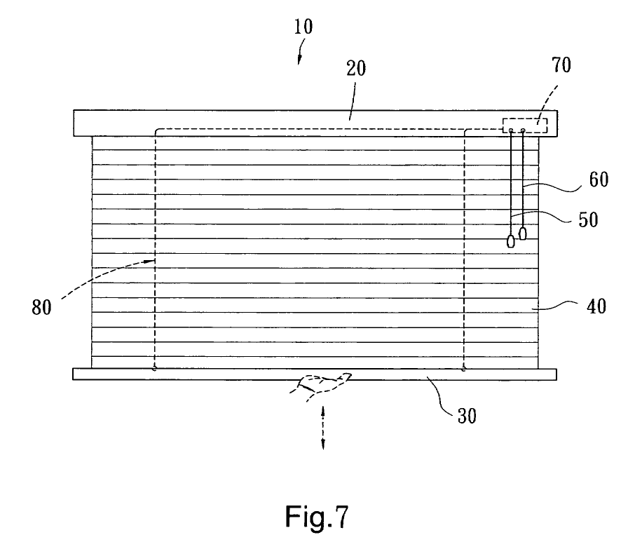

Also referring to FIGS. 6 and 7, in the event that the third ratchet wheel 7232 does not match the first and second ratchet wheels 7211 and 7213, the elastic element 7233 has two ends holding the third ratchet wheel 7232 of the latch roller set 72 and the ratchet wheels 7211 and 7213 at two sides of the winding wheel 721 without forming a match with each other. The lower elongated member 30 may be directly pulled downwards or pushed upwards by hands to retract or release the slat assembly 40. Retracting and releasing the slat assembly 40 can be accomplished through the lift cord retracting and releasing means 70 at the upper elongated member 20 in corporation with the first and second lift cords 50 and 60. The first and second openings 21 and 22 at one side of the bottom of the upper elongated member 20 allow the lift cord assembly 80 to thread through. One end of the first lift cord 50 is fastened to the first winding wheel 732 of the auxiliary gear set 73 and other end winding and threading through the first aperture 714. The second lift cord 60 has one end fastened and wound on the second winding wheel 733 and threading through the second aperture 715 (also referring to FIG. 2).

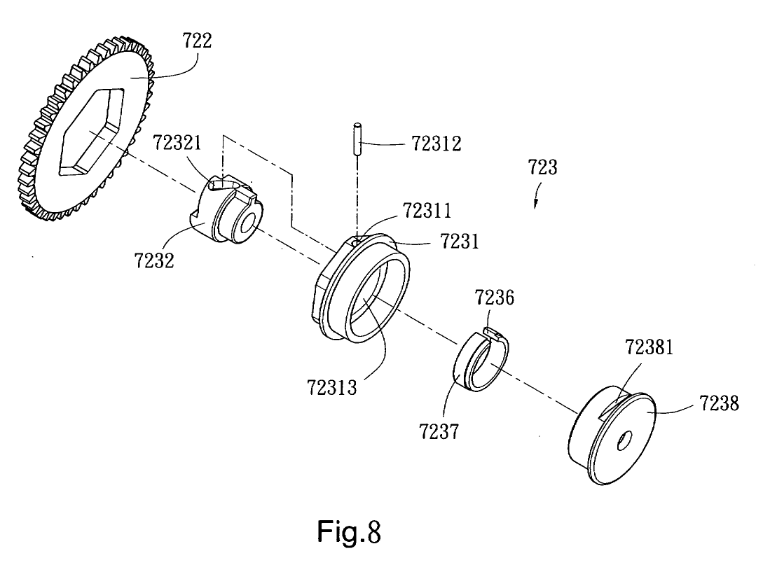

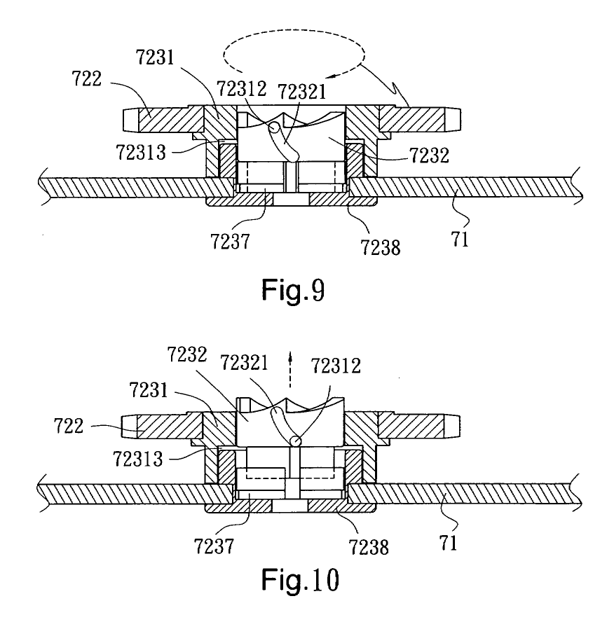

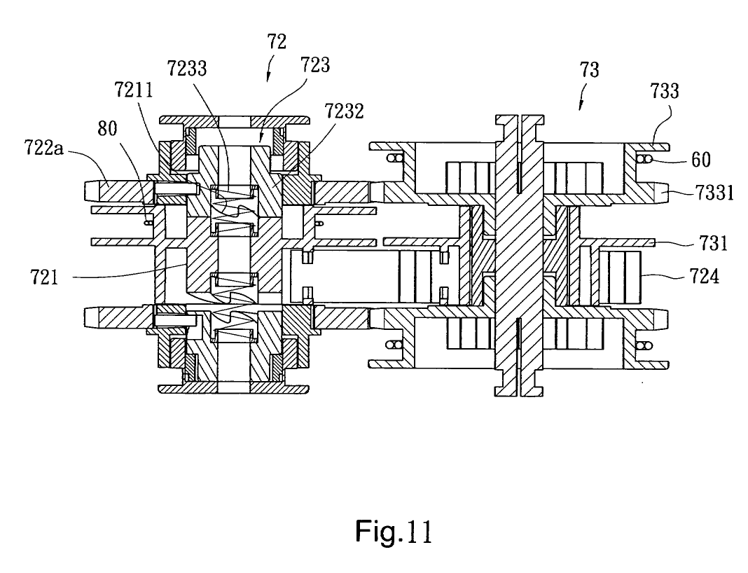

Referring to FIGS. 1 and 8, when the window covering 10 is in use to retract the slat assembly 40, pull the second lift cord 60 downwards to rotate the second winding wheel 733 of the auxiliary wheel set 73; the elastic element 7233 in the latch assembly 723 of the latch roller set 72 pushes the third ratchet wheel 7232 inwards to engage with the first ratchet wheel 7211 at one side of the winding wheel 721, and the second gear 722a and the second winding wheel 733 are engaged and moved together (referring to FIGS. 9, 10 and 11). The elastic element 724 on the spool 731 is wound. The second winding wheel 733 rotates clockwise, and is engaged with the second gear 722a to rotate in the same direction of the auxiliary gear set 73. The latch wheel set 72 rotates and the winding wheel 721 located thereon winds the lift cord assembly 80. The third ratchet wheel 7232 of the latch wheel set 723 is latched with the first ratchet wheel 7211 of the winding wheel 721 (referring to FIG. 11). Thus the slat assembly 40 can be retracted upwards to a selected elevation. Moreover, when the second lift cord 60 is pulled downwards continuously, the slat assembly 40 can be rolled upwards continuously again.

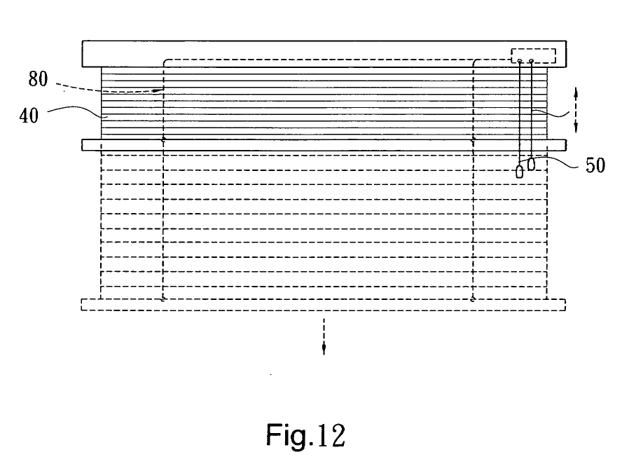

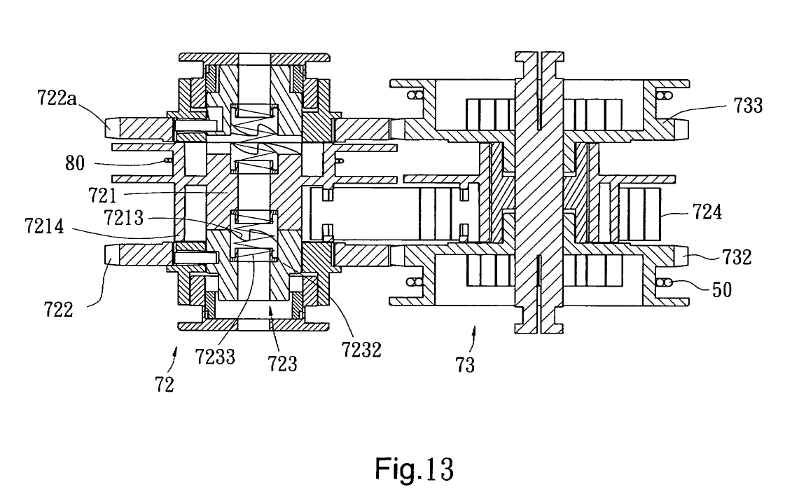

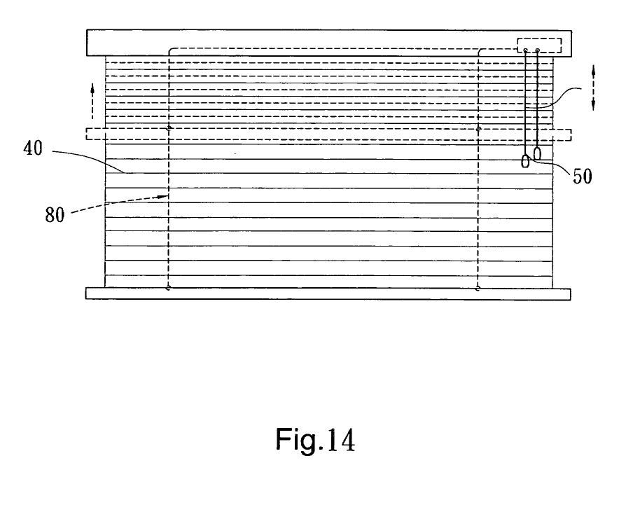

Referring to FIG. 12, to extend the slat assembly 40 downwards to a selected elevation, pull the first lift cord 50 downwards; the first winding wheel 732 of the auxiliary gear set 73 is moved, and the third ratchet wheel 7232 is pushed by the elastic member 7233 inwards to engage with the second ratchet wheel 7213 of the winding wheel 721 so that first gear 722 and the first winding wheel 732 are engaged and moved together (referring to FIG. 13). And the second gear 722a and the second winding wheel 733 that engaged previously are separated (also referring to FIG. 11). The first winding wheel 733 is moved in an opposite direction. The engaged first gear 722 rotates in the opposite direction. Thus the lift cord assembly 80 on the winding wheel 721 is extended downwards (referring to FIG. 14) to lower the slat assembly 40 to a selected elevation to allow users to adjust the indoor luminary condition as desired.

What is claimed is:

1. A window covering, comprising at least:
an upper elongated member;
a lower elongated member which is spaced from the upper elongated member at a lower side and movable downwards or upwards by a user's hand to retract or extend a slat assembly;
a slat assembly which has slats and a lift cord means and an upper end fastened to the upper elongated member and a lower end fastened to the lower elongated member;
a lift cord retracting and releasing control means located on the upper elongated member;
a first lift cord to control the lower elongated member to extend downwards in a staged fashion has one end fastened to the lift cord retracting and releasing control means and other end threading through the upper elongated member; and
a second lift cord to control the lower elongated member to retract upwards in a staged fashion has one end fastened and wound around the lift cord retracting and releasing control means and other end threading through the upper elongated member.

2. The window covering of claim 1, wherein the lift cord retracting and releasing control means includes a latch roller set and an auxiliary gear set.

3. The window covering of claim 2, wherein the lift cord retracting and releasing control means includes a seat which has a first housing compartment to hold the latch roller set and a second housing compartment to hold the auxiliary gear set.

4. The window covering of claim 2, wherein the latch roller set includes at least a winding wheel, a first gear, a second gear, two latch assemblies and an elastic element.

5. The window covering of claim 4, wherein the winding wheel has a winding trough at one end formed with a first ratchet wheel and a round strut at another end with a second ratchet wheel formed thereon.

6. The window covering of claim 4, wherein the two latch assemblies are hanged respectively on the first gear and the second gear and include a positioning member, a third ratchet wheel, an elastic element, a front holding member, a rear holding member and an annular ring which has a notch formed thereon.

7. The window covering of claim 4, wherein the elastic element has two ends forming respectively a latch element.

8. The window covering of claim 2, wherein the auxiliary gear set includes a spool, a first winding wheel, a second winding wheel and two elastic elements.

9. The window covering of claim 8, wherein the spool has a protrusive portion at one end that has a latch trough formed on an outer side and an opening formed therein.

10. The window covering of claim 8, wherein the first winding wheel and the second winding wheel have respectively a gear at one end, a boss in the center which has a through hole and a winding trough at another end that has a housing chamber inside, the housing chamber having a latch ditch formed on an inner rim thereof.
